(19) United States
(12) Patent Application Publication
(10) Pub. No.: US 2023/0184904 A1
(43) Pub. Date: Jun. 15, 2023

(54) POLYGON SCANNING MIRROR WITH FACETS TILTED AT DIFFERENT VERTICAL ANGLES FOR USE IN AN OPTICAL SENSING SYSTEM

(71) Applicant: BEIJING VOYAGER TECHNOLOGY CO., LTD., Beijing (CN)

(72) Inventors: Anan PAN, Fremont, CA (US); Yue LU, Los Gatos, CA (US); Youmin Wang, Berkeley, CA (US)

(73) Assignee: BEIJING VOYAGER TECHNOLOGY CO., LTD., Beijing (CN)

(21) Appl. No.: 17/549,592

(22) Filed: Dec. 13, 2021

(51) Int. Cl. G01S 7/481; G02B 26/12; G02B 26/10; G02B 26/08

(52) U.S. Cl. CPC G01S 7/4817; G02B 26/121; G02B 26/101; G02B 26/0833

(57) ABSTRACT

Embodiments of the disclosure provide for a scanner of an optical sensing system. The scanner may include a polygon scanning mirror with a plurality of facets each configured to steer a light beam towards an object during a scanning procedure. The scanner may include a driver configured to rotate the polygon scanning mirror in a horizontal plane during the scanning procedure. In some embodiments, each of the plurality of facets may be tilted at a different angle with respect to the horizontal plane.

### TECHNICAL FIELD

The present disclosure relates to a polygon scanning mirror for an optical sensing system, and more particularly to, a polygon scanning mirror with facets tilted at different vertical angles such that each facet scans horizontal lines at different vertical angles during a scanning procedure.

### BACKGROUND

Optical sensing systems, e.g., such as LiDAR systems, have been widely used in advanced navigation technologies, such as to aid autonomous driving or to generate high-definition maps. For example, a typical LiDAR system measures the distance to a target by illuminating the target with pulsed laser light beams that are steered towards an object in the far field using a scanning mirror, and then measuring the reflected pulses with a sensor. Differences in laser light return times, wavelengths, and/or phases (also referred to as “time-of-flight (ToF) measurements”) can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

To scan the narrow laser beam across a broad field-of-view (FOV) in two-dimensions (2D), conventional systems mount two separate one-axis scanning mirrors on separate actuators, which drive the scanning mirrors to rotate around their respective axes to scan the two dimensions, respectively. Rotation about one axis provides a fast sweep of the surrounding environment in one dimension and the other axis provides a slow sweeps in an orthogonal dimension. Using these sweeps, a digital 3D image of the far-field can be constructed. The slow axis is typically implemented using mechanical actuator (e.g., a galvanometer) and the fast axis can be implemented by a mechanical or solid-state actuator. The galvanometer may be configured to drive the scanning mirror to rotate about one axis (e.g., slow-sweep), and electrostatic drive combs drive the scanning mirror to rotate about the other axis (e.g., fast-sweep). Using galvanometers in optical sensing systems have various drawbacks, however.

One-such drawback relates to the limited scanning field of view (FOV) in the fast axis. While the polygon scanner used for the slow axis is capable of reaching a large aperture, the solid-state scanner used for the fast axis typically has a smaller aperture. For example, a solid-state scanner may have an aperture spanning less than 30 degrees of scanning angles. Integrating a polygon scanner with a small angle scanner for the other axis becomes an issue to realize effective 2D scanning.

Hence, there is an unmet need for a scanner that provides the benefits of a polygon scanning mirror that can help expand the scanning FOV of the other axis.

### SUMMARY

Embodiments of the disclosure provide for a scanner of an optical sensing system. The scanner may include a polygon scanning mirror with a plurality of facets each configured to steer a light beam towards an object during a scanning procedure. The scanner may include a driver configured to rotate the polygon scanning mirror in a horizontal plane during the scanning procedure. In some embodiments, each of the plurality of facets may be tilted at a different angle with respect to the horizontal plane.

Embodiments of the disclosure provide for a transmitter of an optical sensing system. The transmitter may include a light emitter configured to emit a light beam. The transmitter may also include a scanner. The scanner may include a polygon scanning mirror with a plurality of facets each configured to steer a light beam towards an object during a scanning procedure. The scanner may include a driver configured to rotate the polygon scanning mirror in a horizontal plane during the scanning procedure. In some embodiments, each of the plurality of facets may be tilted at a different angle with respect to the horizontal plane.

Embodiments of the disclosure provide for a scanning method of an optical sensing system. The method may include emitting, by a light emitter, a light beam. The method may also include rotating, by a driver, a polygon scanning mirror with a plurality of facets in a horizontal plane. In some embodiments, each of the plurality of facets may be tilted at a different angle with respect to the horizontal plane. The method may further include steering, by the polygon scanning mirror, the light beam towards an object.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary LiDAR system, according to embodiments of the disclosure.

FIG. 2 illustrates a detailed view of a transmitter that includes an exemplary polygon scanning mirror configured to scan a 2D FOV, according to embodiments of the disclosure.

FIG. 3 illustrates a geometrical view of the different tilts of each of the different facets of the exemplary polygon scanning mirror of FIG. 2, according to embodiments of the disclosure.

FIG. 4 illustrates a graphical representation of the different lines scanned by the facets of the exemplary polygon scanning mirror of FIG. 2, according to embodiments of the disclosure.

FIG. 5 illustrates a flow chart of an exemplary scanning method of an optical sensing system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

LiDAR is an optical sensing technology that enables autonomous vehicles to “see” the surrounding world, creating a virtual model of the environment to facilitate decision-making and navigation. An optical sensor (e.g., LiDAR transmitter and receiver) creates a 3D map of the surrounding environment using laser beams and time-of-flight (ToF) distance measurements. ToF, which is one of LiDAR's operational principles, provides distance information by measuring the travel time of a collimated laser beam to reflect off an object and return to the sensor. Reflected light signals are measured and processed at the vehicle to detect, identify, and decide how to interact with or avoid objects.

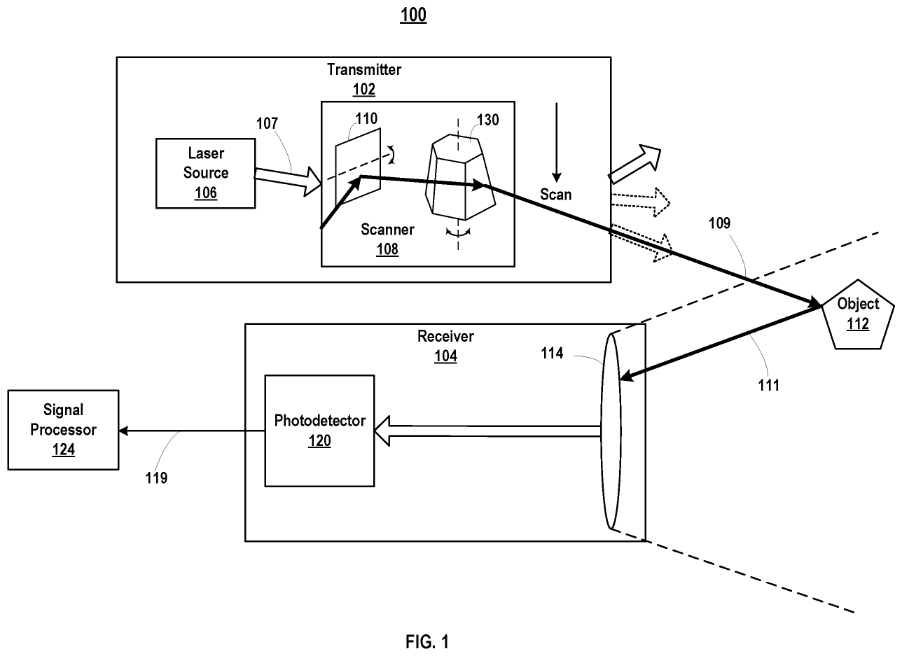

Due to the challenges imposed by using a fast-sweep scanning mirror and a slow-sweep polygon scanning mirror, as discussed above in the BACKGROUND section, the present disclosure provides a scanner with an exemplary polygon scanning mirror that scans a horizontal lines at different vertical positions (also referred to herein as “vertical angles”) to expand the FOV in the vertical dimension. To scan horizontal lines at different vertical positions, each facet of the exemplary polygon scanning mirror is tilted at a different angle with respect to the horizontal plane. Moreover, the transmitter of the present disclosure may include a plurality of light emitters each positioned at different vertical positions. This enables different light beams to impinge on a single facet at different vertical positions. In so doing, each facet may scan horizontal lines at a plurality of different vertical positions. Still further, a planar mirror may be positioned along the light path between the light emitter and the polygon scanning mirror. In the present disclosure, the planar mirror directs the light beam towards the polygon scanning mirror rather than into the far field. When the planar mirror is driven to resonate during a scanning procedure, it may direct a light beam onto a facet in a sinusoidal fashion (up and down) through a range of vertical positions. This enables each facet of the polygon scanning mirror to scan horizontal lines through a range of vertical positions. As the polygon scanning mirror makes a full revolution, a full frame of a 2D FOV may be scanned with an expanded FOV in the vertical dimension. Thus, using the exemplary polygon scanning mirror, the benefits of a stable scan rate associated with polygon scanners can be achieved, while avoiding the integration issues that arise in a two single-axis mirror systems. Additional details of the exemplary polygon scanning mirror and scanning procedure are provided below in connection with FIGS. 1-5.

Some exemplary embodiments are described below with reference to a receiver used in LiDAR system(s), but the application of the emitter array disclosed by the present disclosure is not limited to the LiDAR system. Rather, one of ordinary skill would understand that the following description, embodiments, and techniques may apply to any type of optical sensing system (e.g., biomedical imaging, 3D scanning, tracking and targeting, free-space optical communications (FSOC), and telecommunications, just to name a few) known in the art without departing from the scope of the present disclosure.

FIG. 1 illustrates a block diagram of an exemplary LiDAR system 100, according to embodiments of the disclosure. LiDAR system 100 may include a transmitter 102 and a receiver 104. Transmitter 102 may emit laser beams along multiple directions. Transmitter 102 may include one or more laser sources 106 and a scanner 108.

Transmitter 102 can sequentially emit a stream of pulsed laser beams in different directions within a scan range (e.g., a range of scanning angles in angular degrees), as illustrated in FIG. 1. Each of the pulsed laser beams may scan a horizontal line across the same horizontal angle (e.g., 60° mechanical angle or 120° optical angle) but at different vertical positions with respect to the horizontal plane (e.g., −20° vertical angle, −10° vertical angle, 0° vertical angle, 10° vertical angle, 20° vertical angle, etc.). Laser source 106 may be configured to provide a laser beam 107 (also referred to as “native laser beam”) to scanner 108. In some embodiments of the present disclosure, laser source 106 may generate a pulsed laser beam in the UV, visible, or near infrared wavelength range. Laser beam 107 may diverge in the space between the laser source 106 and the scanner 108. Thus, although not illustrated, transmitter 102 may further include a collimating lens located between laser source 106 and scanner 108 and configured to collimate divergent laser beam 107 before it impinges on scanner 108.

In some embodiments of the present disclosure, laser source 106 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 107 provided by a PLD may be greater than 700 nm, such as 760 nm, 785 nm, 808 nm, 848 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as laser source 106 for emitting laser beam 107.

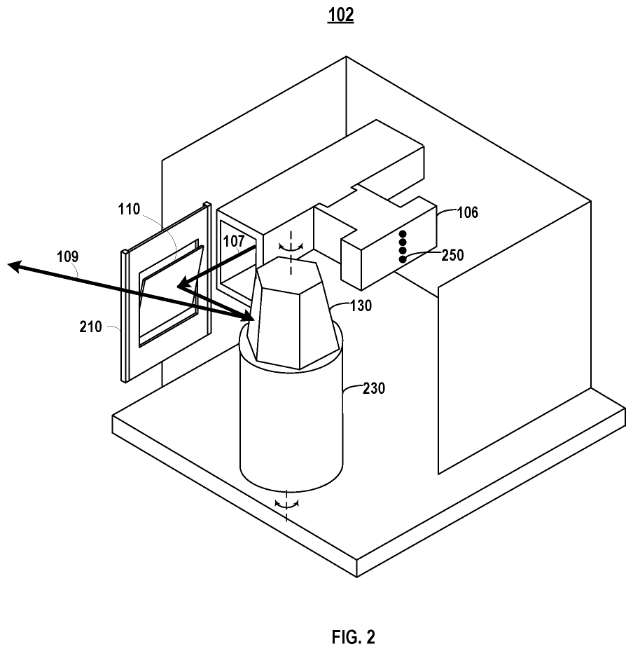

Scanner 108 may be configured to steer a laser beam 109 towards an object 112 (e.g., stationary objects, moving objects, people, animals, trees, fallen branches, debris, metallic objects, non-metallic objects, rocks, rain, chemical compounds, aerosols, clouds and even single molecules, just to name a few) in a direction within a range of scanning angles. In some embodiments consistent with the present disclosure, scanner 108 may include a micromachined mirror assembly, e.g., such as planar mirror 110. Planar mirror 110 may be a microelectricalmechanical (MEMS) mirror. In some embodiments, planar mirror 110 may be static and remained in a fixed position during a scanning procedure. Otherwise, planar mirror 110 may be configured to resonate during the scanning procedure. Although not shown in FIG. 1, the planar mirror assembly of scanner 108 may also include various other elements (shown in FIG. 2). For example, these other elements may include, without limitation, a MEMS actuator, actuator anchor(s), a plurality of interconnects, scanning mirror anchor(s), just to name a few.

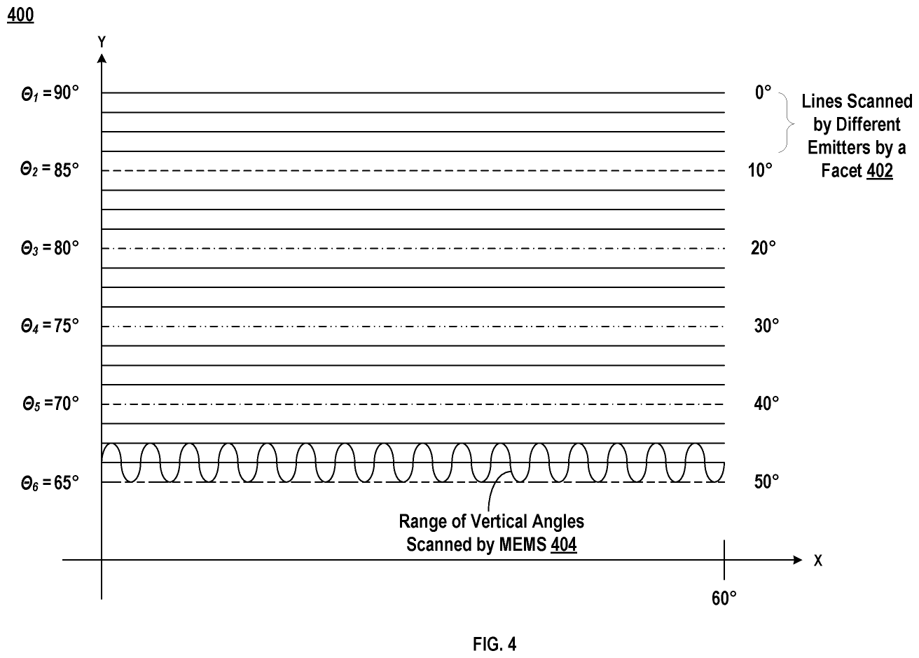

In some embodiments consistent with the present disclosure, scanner 108 may include a polygon mirror assembly, e.g., such as polygon scanning mirror 130. Each facet of polygon scanning mirror 130 may be tilted at a different angle with respect to the horizontal plane. Although not shown in FIG. 1, polygon scanning assembly may include a driver mechanism configured to rotate polygon scanning mirror 130 about its longitudinal axis during the scanning procedure. Because each facet is tilted at a different angle, each facet may be configured to scan a horizontal line of object 112 at a different vertical position with respect to the horizontal plane, e.g., as shown in FIG. 4. Thus, as polygon scanning mirror 130 rotates, each facet scans a horizontal line across a horizontal angle at a particular vertical position, thereby capturing a subframe of a 2D FOV. With each full revolution of polygon scanning mirror 130, a full frame may be scanned of the 2D FOV. The horizontal FOV (the range of horizontal scanning angle) scanned by polygon scanning mirror 130 may be determined based on the number of facets. More specifically, by dividing 360° (mechanical angle) by the number of sides of the polygon scanning mirror 130, the horizontal FOV (mechanical angle) scanned by each facet can be determined. For example, the six-sided polygon illustrated in FIG. 1 scans a horizontal FOV of 60° (mechanical angle), while a three-sided polygon would scan a horizontal FOV of 120° (mechanical angle). Moreover, the horizontal FOV scanned by each facet of polygon scanning mirror 130 in the horizontal plane may be twice the mechanical angle. So, for a six-sided polygon, the horizontal FOV scanned by each facet is 120°, while for a three-sided polygon it would be 240°.

To increase the number of horizontal lines scanned by each facet, laser source 106 may include a plurality of light emitters (shown in FIG. 2) located at different vertical positions. By way of example, if there are four light emitters stacked vertically, each facet will scan four horizontal lines, each at a different vertical position. With a six-sided polygon, each frame would thus include twenty-four horizontal lines scanned at twenty-four vertical positions in the vertical FOV. To fill in the vertical scanning angles between these twenty-four lines, planar mirror 110 may be configured to resonate about its horizontal axis during the scanning procedure. As it resonates, planar mirror 110 directs each of the four light beams towards each facet sinusoidally (up and down), such that each laser beam 109 scans through a range of vertical angles between two horizontal lines. In this way, polygon scanning mirror 130 and planar mirror 110 are configured to collectively scan a 2D FOV of the far-field.

In some embodiments, receiver 104 may be configured to detect a returned laser beam 111 returned from object 112. Returned laser beam 111 may be returned from object 112 and have the same wavelength as laser beam 109. Returned laser beam 111 may be in a different direction from laser beam 109. Receiver 104 can collect laser beams returned from object 112 and output electrical signals reflecting the intensity of the returned laser beams. Upon contact, laser beam 109 can be reflected by object 112 via backscattering, e.g., such as Raman scattering and/or fluorescence.

As illustrated in FIG. 1, receiver 104 may receive the returned laser beam 111. During the scanning procedure, returned laser beam 111 may be collected by lens 114 as laser beam 121. Photodetector array 120 may convert the laser beam 121 (e.g., returned laser beam 111) collected by lens 114 into an electrical signal 119 (e.g., a current or a voltage signal). Electrical signal 119 may be generated when photons are absorbed in a photodiode included in photodetector array 120. In some embodiments of the present disclosure, photodetector array 120 may include a PIN detector, a PIN detector array, an avalanche photodiode (APD) detector, a APD detector array, a single photon avalanche diode (SPAD) detector, a SPAD detector array, a silicon photo multiplier (SiPM/MPCC) detector, a SiP/MPCC detector array, or the like.

LiDAR system 100 may also include one or more signal processor 124. Signal processor 124 may receive electrical signal 119 generated by photodetector array 120. Signal processor 124 may process electrical signal 119 to determine, for example, distance information carried by electrical signal 119. Signal processor 124 may construct a point cloud based on the processed information. The point cloud may include a frame, which is an image of the far-field at a particular point in time. In this context, a frame is the data/image captured of the far field environment within the 2D FOV (horizontal FOV and vertical FOV). Signal processor 124 may include a microprocessor, a microcontroller, a central processing unit (CPU), a graphical processing unit (GPU), a digital signal processor (DSP), or other suitable data processing devices.

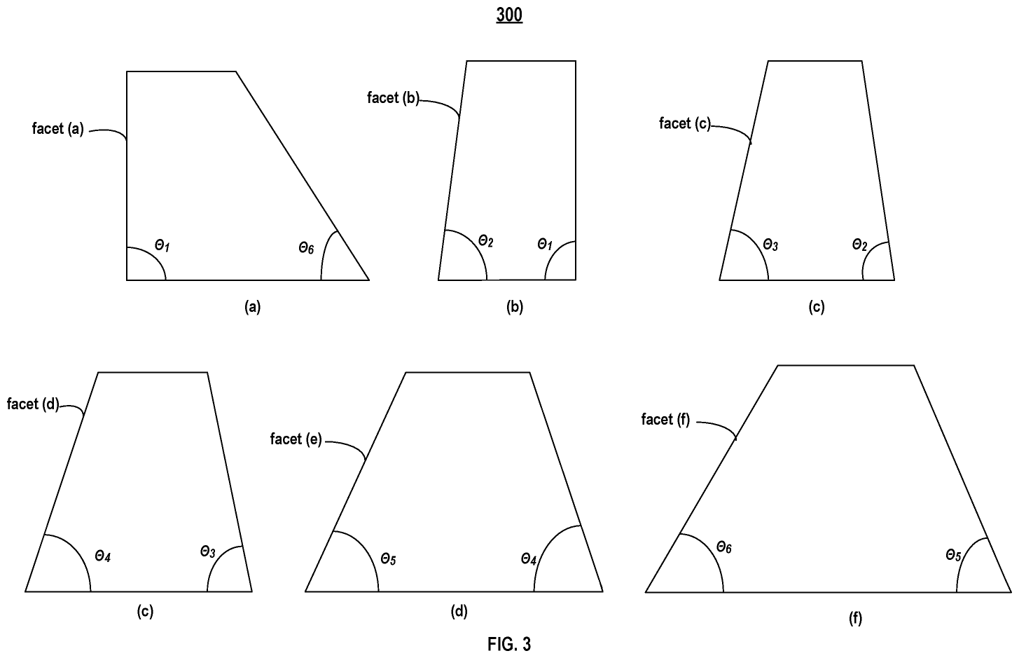

FIG. 2 illustrates a detailed view of transmitter 102 of FIG. 1 including the exemplary polygon scanning mirror 130, according to embodiments of the disclosure. FIG. 3 illustrates a geometrical view of the different vertical angles at which each of the facets of the exemplary polygon scanning mirror 130 are tilted, according to embodiments of the disclosure. FIG. 4 illustrates a graphical representation of the different horizontal lines scanned by the exemplary polygon scanning mirror 130 at different vertical positions, according to embodiments of the disclosure. FIGS. 2-4 will be described together.

Referring to FIG. 2, transmitter 102 includes laser source 106, planar mirror assembly 210 with planar mirror 110, and polygon scanning assembly 230 with polygon scanning mirror 130. Polygon scanning assembly 230 may include a driver configured to rotate polygon scanning mirror 130 at a steady scan rate. The driver may include any type of device or mechanism that can rotate polygon scanning mirror 130 in the horizontal axis. Although polygon scanning mirror 130 is shown with six facets, it is understood that polygon scanning mirror 130 can have any number of facets (three or more) without departing from the scope of the present disclosure. Thus, the examples provided below in connection with a six faceted polygon scanning mirror can be extended to a polygon scanning mirror with more or fewer than six facets, as would be readily understood by one of ordinary skill in the art. Moreover, each facet can be tilted at any vertical angle so long as one or more of the facets are tilted at a different vertical angle. Examples of the angles at which each of the six facets (a)-(f) of polygon scanning mirror 130 are tilted are depicted in FIG. 3.

As shown in FIG. 3, facet (a) has a vertical tilt angle θ₁=90°, facet (b) has a vertical tilt angle θ₂=85°, facet (c) has a vertical tilt angle θ₃=80°, facet (d) has a vertical tilt angle θ₄=75°, facet (e) has a vertical tilt angle θ₅=70°, and facet (f) has a vertical tilt angle θ₆=65°. As mentioned above, due to the different angles at which the facets are tilted, each facet scans a horizontal line at a different vertical position, e.g., examples of which are as shown in FIG. 4.

Referring to FIG. 4, assuming laser beam 107 is directed horizontally at each facet, facet (a) may steer laser beam 109 into the far-field such that a horizontal line is scanned at a vertical position associated with a vertical scanning angle of 0°. Facet (b) may steer laser beam 109 into the far-field such that a horizontal line is scanned at a vertical position associated with a vertical scanning angle of −10°. Facet (c) may steer laser beam 109 into the far-field such that a horizontal line is scanned at a vertical position associated with a vertical scanning angle of −20°. Facet (d) may steer laser beam 109 into the far-field such that a horizontal line is scanned at a vertical position associated with a vertical scanning angle of −30°. Facet (e) may steer laser beam 109 into the far-field such that a horizontal line is scanned at a vertical position associated with a vertical scanning angle of −40°. Facet (f) may steer laser beam 109 into the far-field such that a horizontal line is scanned at a vertical position associated with a vertical scanning angle of −50°.

Referring again to FIG. 2, laser source 106 includes a plurality of light emitters 250 stacked vertically. For example, light emitters 250 may include a laser bar, an edge-emitting laser, or the like. In either case, each light emitter 250 may sequentially emit laser beam 107. Because of the vertical positioning, the laser beam 107 emitted by each light emitter 250 will impinge (assuming planar mirror 110 is not resonating) at a different position on a facet with respect to the horizontal plane. The following example will be described in connection with four light emitters 250. However, more or few than four light emitters 250 may be included in laser source 106 without departing from the scope of the present disclosure.

Turning again to FIG. 4, assume four light emitters 250 are positioned vertically above one another and that planar mirror 110 is not resonating. Here, each facet will scan four horizontal lines located at vertical positions separated by −2.5°. The lines between 0° and 10° may be referred to as intermediate lines, which are each associated with an intermediate scanning angle (e.g., −2.5°, −5°, and)−7.5°. The space between the horizontal lines scanned by a facet is dependent on the vertical spacing of the light emitters 250, among other things. In the example shown in FIG. 4, facet (a) scans horizontal lines 402 at 0°, −2.5°, −5°, and −7.5°, facet (b) scans horizontal lines 402 at 10°, −12.5°, −15°, and −17.5°, and so on. Thus, by including more than one light emitter 250 at different vertical positions within transmitter 102, each facet can be made to scan more than one horizontal line. Then, to ensure the optical angles between each of the four horizontal lines 402 are also scanned, planar mirror 110 can be made to resonate about its horizontal axis, as depicted in FIG. 2. As planar mirror 110 resonates about its horizontal axis, each laser beam 107 can be made to impinge upon a facet at many different places with respect to the horizontal plane. Consequently, horizontal lines are scanned at a series of different vertical angles 404. For example, for facet (a), the laser beam 107 that scans a horizontal line at 0° can also be made to scan horizontal lines through a range of vertical angles 404 between 0° to −2.5° as planar mirror 110 resonates. In this way, a detailed 3D point cloud can be reconstructed based on the 2D FOV scanned by polygon scanning mirror 130 and planar mirror 110. The 2D FOV scanned by polygon scanning mirror 130 and planar mirror 110 in the example depicted in FIG. 4 is 120° (horizontal FOV) by 50° (vertical FOV).

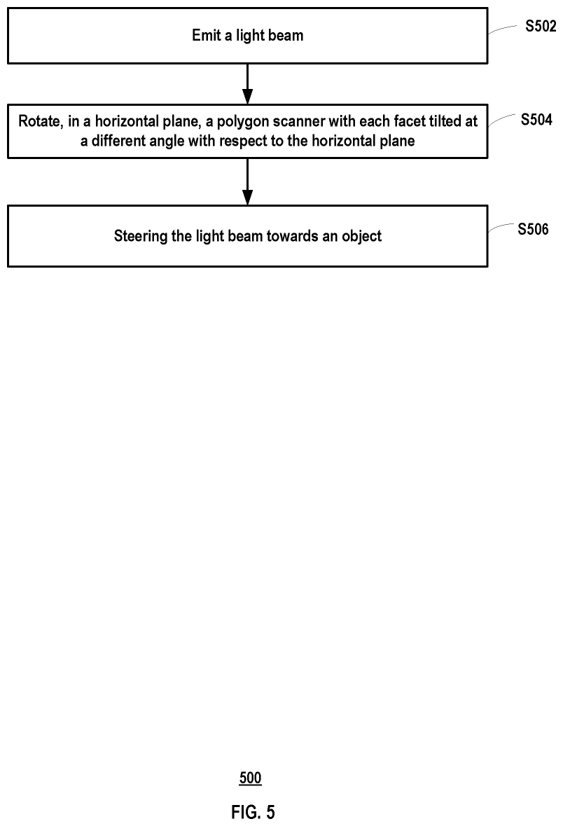

FIG. 5 illustrates a flowchart of an exemplary scanning method 500 of an optical sensing system, according to embodiments of the disclosure. Scanning method 500 may be performed by, e.g., transmitter 102 of FIGS. 1 and 2. Method 500 may include steps S502-S506 as described below. It is to be appreciated that some of the steps may be optional, and some of the steps may be performed simultaneously, or in a different order than shown in FIG. 5.

Referring to FIG. 5, at S502, the transmitter may emit a light beam by one or more light emitter. For example, referring to FIG. 2, laser source 106 includes a plurality of light emitters 250 stacked vertically. Each light emitter 250 may sequentially emit laser beam 107. Because of the vertical positioning, the laser beam 107 emitted by each light emitter 250 will impinge (assuming planar mirror 110 is not resonating) at a different position on a facet with respect to the horizontal plane.

At S504, the transmitter may rotate a polygon scanning mirror in a horizontal plane. The polygon scanning mirror may include a plurality of facets each tilted at a different angle with respect to the horizontal plane. For example, referring to FIG. 2, polygon scanning assembly 230 may include a driver configured to rotate polygon scanning mirror 130 at a steady scan rate. The driver may include any type of device or mechanism that can rotate polygon scanning mirror 130 in the horizontal axis. As the example of FIG. 3 shows, polygon scanning mirror 130 may have six facets, tilted at vertical angles of θ₁=90°, θ₂=85°, θ₃=80°, θ₄=75°, θ₅=70°, and θ₆=65°, respectively.

At S506, the transmitter may steer, by the polygon scanning mirror, the light beam towards an object. For example, referring to FIG. 1, transmitter 102 can sequentially emit a stream of pulsed laser beams in different directions within a scan range (e.g., a range of scanning angles in angular degrees), as illustrated in FIG. 1. Each of the pulsed laser beams may scan a horizontal line across the same horizontal FOV (e.g., 60° mechanical angle or 120° optical angle) but at different vertical positions with respect to the horizontal plane (e.g., −20° vertical scanning angle, −10° vertical scanning angle, 0° vertical scanning angle, 10° vertical scanning angle, 20° vertical scanning angle, etc.).

The exemplary polygon scanning mirror 130 described above in connection with FIGS. 1-5 scans horizontal lines at different vertical positions to capture a 2D FOV without a single-axis mirror to scan the vertical axis. To scan horizontal lines at different vertical positions, each facet of the exemplary polygon scanning mirror 130 is tilted at a different angle with respect to the horizontal plane, as depicted in FIG. 3. Moreover, the transmitter 102 of the present disclosure may include a plurality of light emitters 250 each positioned at different vertical positions. This enables different light beams to impinge on a single facet at different vertical positions. In so doing, each facet may scan horizontal lines at a plurality of different vertical positions, thus expanding the vertical FOV. Still further, a planar mirror 110 may be positioned along the light path between the light emitter 250 and the polygon scanning mirror 130. Consistent with the present disclosure, the planar mirror 110 directs the light beam towards the polygon scanning mirror rather than into the far-field. When the planar mirror 110 is driven to resonate during a scanning procedure, it may direct a light beam onto a facet in a sinusoidal fashion (up and down) through a range of vertical positions. This enables each facet of the polygon scanning mirror 130 to scan horizontal lines through a range of vertical positions. As the polygon scanning mirror 130 makes a full revolution, a full frame of a 2D FOV is scanned. Thus, using the exemplary polygon scanning mirror 130, the benefits of a stable scan rate associated with polygon scanners can be achieved, while avoiding the integration issues that arise in a two single-axis mirror systems.

It is intended that the specification and examples be considered as exemplary only, with a true scope being indicated by the following claims and their equivalents.

What is claimed is:

1. A scanner of an optical sensing system, comprising:
a polygon scanning mirror with a plurality of facets each configured to steer a light beam towards an object during a scanning procedure; and
a driver configured to rotate the polygon scanning mirror in a horizontal plane during the scanning procedure,
wherein each of the plurality of facets is tilted at a different angle with respect to the horizontal plane.

2. The scanner of claim 1, wherein one of the plurality of facets is configured to scan the object in the horizontal plane and a vertical plane simultaneously as the polygon scanning mirror rotates.

3. The scanner of claim 1, wherein each of the plurality of facets is configured to scan a horizontal line of the object at a different vertical position.

4. The scanner of claim 3, wherein each of the plurality of facets is configured to scan the horizontal line of the object at a same horizontal angle.

5. The scanner of claim 1, wherein a first facet of the plurality of facets is configured to scan a first line at a first vertical position and a second facet of the plurality of facets is configured to scan a second line at a second vertical position.

6. The scanner of claim 5, further comprising:
a microelectricalmechanical (MEMS) mirror configure to direct the light beam towards the first facet at a plurality of incident angles such that the first facet scans the first line at the first vertical position and at least one intermediate line at one or more intermediate vertical positions between the first vertical position and the second vertical position.

7. The scanner of claim 6, wherein:
the at least one intermediate line includes a plurality of intermediate lines between the first line and the second line,
each of the plurality of intermediate lines is associated with one of the plurality of incident angles, and
each of the plurality of intermediate lines is associated with a different intermediate vertical position between the first vertical position and the second vertical position.

8. The scanner of claim 6, wherein the MEMS mirror is configured to resonate to direct the light beam towards the first facet at the plurality of incident angles.

9. A transmitter of an optical sensing system, comprising:
a light emitter configured to emit a light beam; and
a scanner comprising:
a polygon scanning mirror with a plurality of facets each configured to steer the light beam towards an object during a scanning procedure; and
a driver configured to rotate the polygon scanning mirror in a horizontal plane during the scanning procedure,
wherein each of the plurality of facets is tilted at a different angle with respect to the horizontal plane.

10. The transmitter of claim 9, wherein one of the plurality of facets is configured to scan the object in the horizontal plane and a vertical plane simultaneously as the polygon scanning mirror rotates.

11. The transmitter of claim 9, wherein each of the plurality of facets is configured to scan a line of the object at a different vertical position.

12. The transmitter of claim 11, wherein each of the plurality of facets is configured to scan the line of the object at a same horizontal angle.

13. The transmitter of claim 9, wherein a first facet of the plurality of facets is configured to scan a first line at a first vertical position and a second facet of the plurality of facets is configured to scan a second line at a second vertical position.

14. The transmitter of claim 13, further comprising:
a microelectricalmechanical (MEMS) mirror configure to direct the light beam towards the first facet at a plurality of incident angles such that the first facet scans the first line at the first vertical position and at least one intermediate line at one or more intermediate vertical positions between the first vertical position and the second vertical position.

15. The transmitter of claim 14, wherein:
the at least one intermediate line includes a plurality of intermediate lines between the first line and the second line,
each of the plurality of intermediate lines is associated with one of the plurality of incident angles, and
each of the plurality of intermediate lines is associated with a different intermediate vertical position between the first vertical position and the second vertical position.

16. The transmitter of claim 14, wherein the MEMS mirror is configured to resonate to direct the light beam towards the first facet at the plurality of incident angles.

17. The transmitter of claim 9, wherein the light emitter includes a plurality of light emitters each oriented at a different position with respect to a vertical axis.

18. The transmitter of claim 17, wherein the plurality of light emitters are configured to emit the light beam sequentially such that one of the plurality of facets of the polygon scanning mirror scans a plurality of different lines each associated with a different vertical position.

19. The transmitter of claim 17, wherein the plurality of light emitters include a laser bar or an edge-emitting laser.

20. A scanning method of an optical sensing system, comprising:
emitting, by a light emitter, a light beam;
rotating, by a driver, a polygon scanning mirror in a horizontal plane, wherein the polygon scanning mirror includes a plurality of facets each tilted at a different angle with respect to the horizontal plane; and
steering, by the polygon scanning mirror, the light beam towards an object.
